(19) United States
(12) Patent Application Publication
(10) Pub. No.: US 2014/0173417 A1
(43) Pub. Date: Jun. 19, 2014

(54) Method and Apparatus for Archiving and Displaying historical Web Contents

(71) Applicant: Xiaopeng He, North Potomac, MD (US)

(72) Inventor: Xiaopeng He, North Potomac, MD (US)

(21) Appl. No.: 14/072,836

(22) Filed: Nov. 6, 2013

Related U.S. Application Data
(60) Provisional application No. 61/738,443, filed on Dec. 18, 2012.

(51) Int. Cl. G06F 17/22

(52) U.S. Cl. CPC G06F 17/2247
USPC 715/234

(57) ABSTRACT

Method and apparatus are provided for transforming and archiving web contents on the network for later display of the contents as historical records. The embodiments of this invention enable the display of historical web contents in their original layout, format, styles and functionalities after they have been modified or even removed from the web server hosting the web contents.

### CROSS REFERENCE TO RELATED APPLICATION

This application claims the priority to currently pending U.S. Provisional Patent Application Ser. No. 61/738,443 filed on Dec. 18, 2012 titled “Method and Apparatus for Archiving and Displaying Historical Web Contents”.

### FIELD OF THE INVENTION

This invention relates to the field of computer technology. More specifically, the invention relates to methods and apparatus for transforming and archiving web contents for later display as historical records.

### BACKGROUND OF THE INVENTION

As we entering the WEB2.0 age and beyond, the World Wide Web becomes increasingly popular for businesses as well as for general public. The amount of web contents is increasing exponentially, not only from the perspective of the amount of information, but also from the perspective of the number of areas of our social life. This movement is further fueled by the wide spread adoption of paper-less policy from organizations around the globe. Almost everything is moving towards the web. The proof of such trend is that big data is now a hot topic among technology and business thought leaders. The web becomes such an indispensable part of our daily life, especially among young generations. By all means, the World Wide Web is a revolutionary phenomenon. With wide spread connections on the web, the entire world becomes much smaller.

Web content, dynamic or static, is at the center of the revolution. Numerous web contents are generated and updated every day, every minute around the globe. Through web contents, we keep up with events going on around us and in the world. We exchange information via web contents. We express ourselves by writing webpages or blogs. People sell and buy things from various websites. People connect with other people via twitters, Facebook and other social network websites. Organizations publish news and products on the web. Publishing has never been so easy. Anybody can publish their work on the web as long as they have access to the Internet. Increasing population reads and writes Email messages from the web using popular web mails such as Hotmail, Gmail etc. For many people, Web is their only source of information.

Due to the diversified and distributed nature of the web, web contents are generated and managed by many different organizations and individuals. Web contents are hosted and serviced statically or dynamically from many web servers around the world. Web contents are updated periodically by the owners of the individual website or webpages. Some web contents are updated annually, quarterly, monthly, or daily. Some web contents are updated almost instantly, as new contents are injected into the system. This is especially true for gateway and news publishing sites. The question is, as a web user, how do we get the web contents published yesterday from a particular website? There are many reasons why we want to see historical web contents. It could be some economic data published a month ago from a website. It could be a competitive sales offer published a few days ago by a manufacturer or dealer. It could be a policy offered by an insurance company which made some updates to the original terms a few weeks ago. It could be a public schedule or statement that has been changed recently. It could be a blog content that has been removed from the webpage. It could be a unique and inspirational user interface design of a webpage that has been revised lately. It could be really anything that was available in the past but is not now or has been updated since you visited last time. It could be anything visual on a webpage that has been modified, updated, relocated or even removed from a webpage or website.

To satisfy the need to view historical web contents, several prior arts have been invented at the level of individual websites. For example, if you visit some news publishing websites, such as The Wall Street Journal, you can search news within a specified period of time back to past 4 years. Some other sites may provide navigation tools allowing users to navigate to historical contents back to certain number of days. The obvious issue with this approach is that it is totally under the control of the organization or owner of the website. If the web content is removed from the website, you lose the access to the information permanently. Another method of saving historical web contents is by displaying the web content in a browser, taking a screen shot of the browser window, and then saving the screen shots to local hard drives for later access. The problem with this approach is that taking the snapshot is not only tedious, the recorded web contents are also not functional at all since the snapshot is merely a static image reflecting the state of the webpage when the snapshot was taken. Managing the snapshots can be very tedious and error prone if you have more than a couple of webpages to manage. To get around this problem, yet another approach is to download the webpage using a browser control, and save the downloaded webpage in its original format to local disk for later access. However, since a webpage may contain references to external resources such as icons, JavaScript, cascading style sheet etc., launching the archived webpage from a local hard drive may not fully restore the look and feel of the original webpage, if the external resources are referenced in the fashion of relative URLs, or the external resources are modified or missing from the website at the time you run the saved webpage. So, a bigger question becomes how do we archive contents on the web, and serve the contents to end users as historical records in a systematic and methodical way without losing visual and behavior details?

Wayback Machine (www.archive.org) innovated a method of systematic and automatic archiving of web contents. It uses a web crawler to get web contents periodically from the World Wide Web. By providing the URL of a web page, a user can get all the historical records that Weyback Machine has archived for the web content identified by the URL. However, the biggest issue with Wayback Machine is that you may not be able to get the historical records of the web page that you are interested in, if the web page has not been visited by the web crawler yet. Wayback Machine declares on their website that it's not possible for end users to force the web crawler to archive a specific web page, because the web crawler has its own methods to discover websites to crawl. It doesn't take “crawl my site now!” submissions. Such a design really limits the usefulness of Wayback machine as an Internet service. It doesn't fully reflect the popularity of a webpage that it archives, and it doesn't adhere to the spirit of Web 2.0 by which Internet contents are populated and archived by initiations from end users not from backend machines. Some other issues with the current Wayback Machine include but not limited to the quality of the archived web contents are very limited that when replayed it doesn't really reproduce the look and feel of the web content when it's been archived. Also it doesn't archive the web contents referenced by and played from within browser plug-ins such as Java Applet and ActiveX controls. When an archived web page that contains browser plug-ins is replayed from Wayback Machine, the browser area where the embedded browser plug-in residing is shown blank. Wayback Machine is not a complete solution.

This invention provides methods and apparatus for archiving all contents on the web for later display of the contents precisely in the way that the contents were served from the original website, even after they are physically removed from the original hosting websites. And the archiving activities are initiated and triggered by end users.

### SUMMARY OF THE INVENTION

It is an object of this invention to provide a computer software system that maintains historical records for contents on the web that are going through the process of modifications, updating and possibly deletions.

It is yet another object of this invention to provide a computer software system that allows the display of historical web contents without losing fidelities in terms of data, layouts, colors, styles, and even functionalities.

It is yet another object of this invention to provider a computer software system that archives public or private web contents in a user-driven manner.

It is yet another object of this invention to provide a computer software system that allows the archiving of web contents regardless how the web contents are originally presented to the end users, including but not limited to web contents presented from HTML pages as well as web contents presented from within browser plug-ins of various kinds.

It is yet another object of this invention to provide a web contents archiving method comprising an user-driven process that is initiated by end users with resource URLs, and a recursive web content transformation process at the server side for processing the end user provided resource URLs, and an incremental web contents archiving mechanism by which only modified web contents will be archived in the repository as new revisions.

It is yet another object of this invention to provide a method for presenting the archived web contents to end users, including but not limited to displaying a list of revisions of archived web contents, displaying the content of a specified revision of archived web contents with a timestamp indicating when the web content being archived, providing side-by-side comparison of two or more revisions of the web contents, and providing content change notifications to parties who are interested.

### BRIEF DESCRIPTION OF THE DRAWINGS

FIG. 1 illustrates one embodiment of this invention where a special website is setup on the network for users to retrieve and browse the history of changes made to webpages and other types of contents on the web addressable by resource URLs.

FIG. 2A is a high level flowchart illustrating from an end user perspective the process of retrieving the change histories of content on the web addressed by a fully qualified resource URL. Each archive URL addresses a specific version of the web content archived in the system.

FIG. 2B is a high level flowchart illustrating from an end user perspective the process of displaying a revision of the web content by selecting an archive URL.

FIG. 3A is a flowchart illustrating the process of archiving and versioning a web content addressed by a resource URL.

FIG. 3B is a flowchart illustrating the web content transformation process.

FIG. 4A is a flowchart illustrating the process of preparing for the handling of secondary resources required by Java Applet.

FIG. 4B is a flowchart illustrating the process of archiving and delivering secondary resources.

FIG. 5 illustrates a sample HTML page before and after transformation.

FIG. 6 illustrates a collection of web content objects in the web content repository.

FIG. 7A is a sample HTML snippet with a Java Applet embedded.

FIG. 7B is a sample HTML snippet with a Java Applet embedded after transformation.

### DETAILED DESCRIPTION OF THE INVENTION

It is recognized that most contents on the web are addressable and accessible via URLs (Uniform Resource Locator). URLs addressing contents on the web are often referred to as resource URLs. There are two forms of resource URLs: long form which is often referred to as absolute URL; and short form which is often referred to as relative URL. A resource on the web can be addressed by both forms. An absolute URL contains more information than a relative URL. Extra information includes the communication protocols such as http, https, ftp etc.; the domain or server name; the application path; and query parameters etc. Relative URLs are more convenient because they are shorter and often more portable. However, relative URLs can only be used to reference resources on the same server. By typing in an absolute URL into the address bar of a web browser window, hitting the return key, users can display the content on the web addressed by the URL in the browser. This technique applies to all web contents regardless of whether the web contents are statically hosted or dynamically generated from the hosting website, and regardless of the type of the web content. Using this technique, our approach for web content archiving is to, provided a valid resource URL, download the web content addressed by the resource URL, parse the downloaded content in order to get a list of references to external resources that the web content may contain, and then download all the external references and save them into a content management system for later access. The most important step during the entire process is to transform the web content so that all references to the external resources are changed to the corresponding references to the respective resources that are archived in the content management system. Transformation guarantees that when the archived web content is retrieved from the repository and displayed from a browser, all referenced external resources are still available in their original format, style and functionalities when the resources on the web were downloaded. Without the transformation step, launching archived web content in a browser may result in different format, style or functionalities if the web content contains references to external resources and the URLs for external resource are in the form of relative URLs, or the external resources have been modified from the hosting website. Or users may even get “File not found” error if the referenced external resources have been removed from the hosting website.

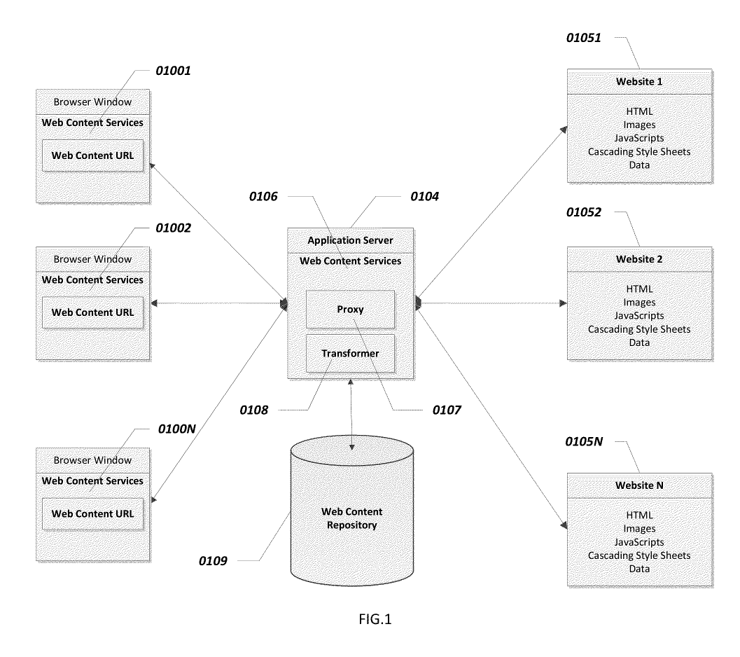

FIG. 1 illustrates an embodiment of this invention comprising a Web Content Services 0106, a Web Content Repository 0109 and browser windows hosting Web Content Services 01001 through 0100N respectively. Web Content Services 0106 is a special service hosted on Application Server 0104. Application Server 0104 is connected to Web Content Services 01001 through 0100N at one side, and public Website 01051 through 0105N at the other via public network such as Internet. Web Content Services 0106 is connected to Web Content Repository 0109 via private or public network connections. Web Content Repository 0109 is publicly accessible from Web Content Services 01001 through 0100N only when Web Content Repository 0109 is also responsible for delivering archived web contents directly to the requesting clients. Website 01051, 01052 and 0105N are all in the public domain. Browser windows have direct access to Website 01051 through Website 0105N. Web contents, including but not limited to HTML pages, Java Script files, cascading style sheet, image files, video/audio files, business documents and data etc. that are hosted and served from Website 01051 through 0105N can be directly displayed and used in browser windows. While with Web Content Services 0100N hosted, browser window is able to serve end users' need to browse information for histories of a webpage or other contents on the web that may or may not be available directly from Website 0105N at the time when end users need them. Historical web contents are archived in Web Content Repository 0109. Prior archiving, web contents are hosted and served from public websites 01051 through 0105N. Website 01051, 01052 and 0105N are hosted on application servers respectively separate from Application Server 0104. Changes made to the various web contents hosted on Website 01051 through 0105N are recorded and archived in Web Content Repository 0109. Web Content Services 0106 downloads the web contents from various public websites, and then archive the contents into Web Content Repository 0109 for later access as historical records. From browser window that hosts Web Content Services 01001, for example, with an input of an absolute URL for a resource on the web, user can query Web Content Services 0106 for all updates of the web content addressed by the provided resource URL, and display each revision of the web content in the browser window. Web Content Services 0106 comprises Proxy 0107 and Transformer 0108. Proxy 0107 is responsible for downloading web contents from a public website, for example Website 01051, in the exact same way that a browser window downloading web contents from the website. Transformer 0108 is responsible for transforming the raw web content downloaded from a public website, for example Website 01051, in the way that the transformed web content can be directly consumed by and displayed in a browser window without loss of fidelity and functionalities. Not all types of web contents require content transformation. Images files such as JPEG, PGN, GIF and video/audio files and business documents do not require content transformation. They can be archived directly into Web Content Repository 0109. HTML pages, cascading style sheet and Java script files may potentially contain references to external resources thus must be transformed before being archived in the repository. Without content transformation, when replayed from a browser window the web content will have broken links and other loss of fidelities. Proxy 0107 is also responsible for archiving into and retrieving from Web Content Repository 0109 the transformed web contents, and delivering them to browser windows when requested. Web Content Services 01001 through 0100N is just one type of the clients which require the information about web content histories. Web Content Services 0106 is able to serve other types of clients too for their requests on web content histories.

End users use the web content history service by launching a web browser and pointing to an application server that hosts Web Content Services 0106. Web Content Services 01001 is instantiated on the browser window at the client side. The Web Content Services 01001 presents an input field and a button to the end user who can input an absolute URL for a specific web content that the user wants to look up histories. By clicking the button, the end user sends the request for web content history to Web Content Services 0106. The Web Content Services 0106 listens to requests from clients for web content histories. Upon receiving a web content history request from a client, the Web Content Services 0106 uses the resource URL as the key to query Web Content Repository 0109 for archived records. It returns a list of archive URLs to the client with each archive URL representing one version of the web content updated in the past over the time. The Web Content Services 0106 is also responsible for downloading and archiving the requested web content from public websites on behalf of end users as a new version if needed in the repository. Records for specific web content are established by the first time use of Web Content Services 0106 for the web content. Web content histories are accumulated in Web Content Repository 0109 by end users' continued usage of Web Content Services 0106 around the globe.

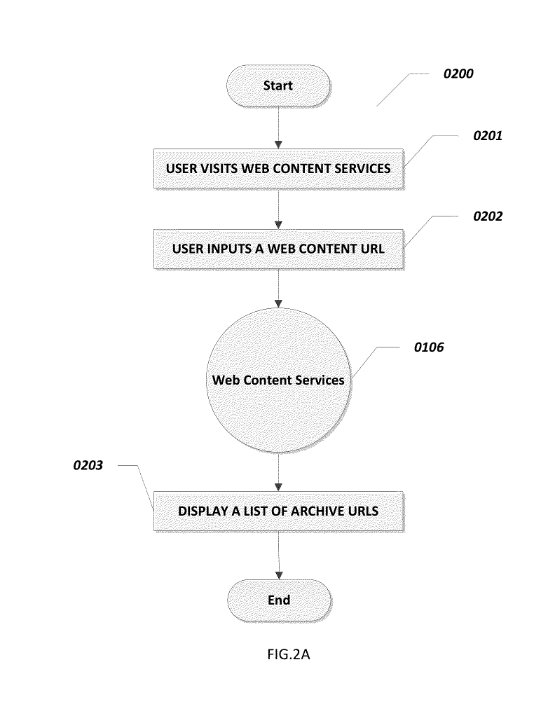

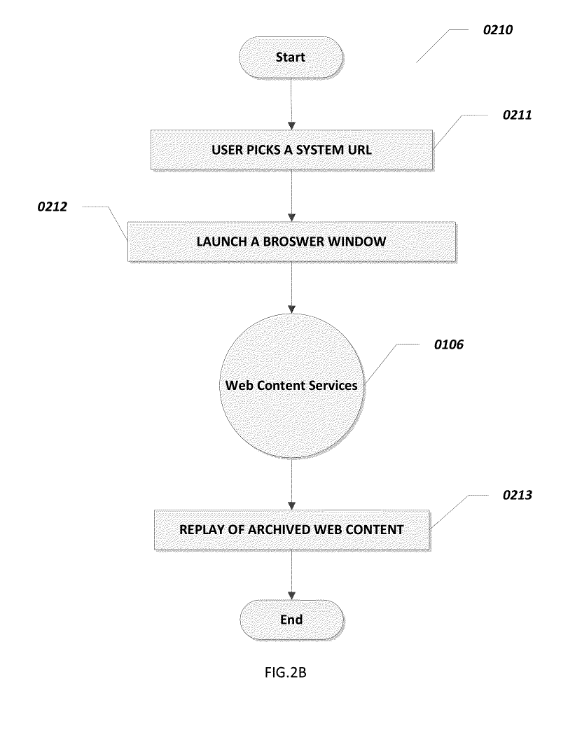

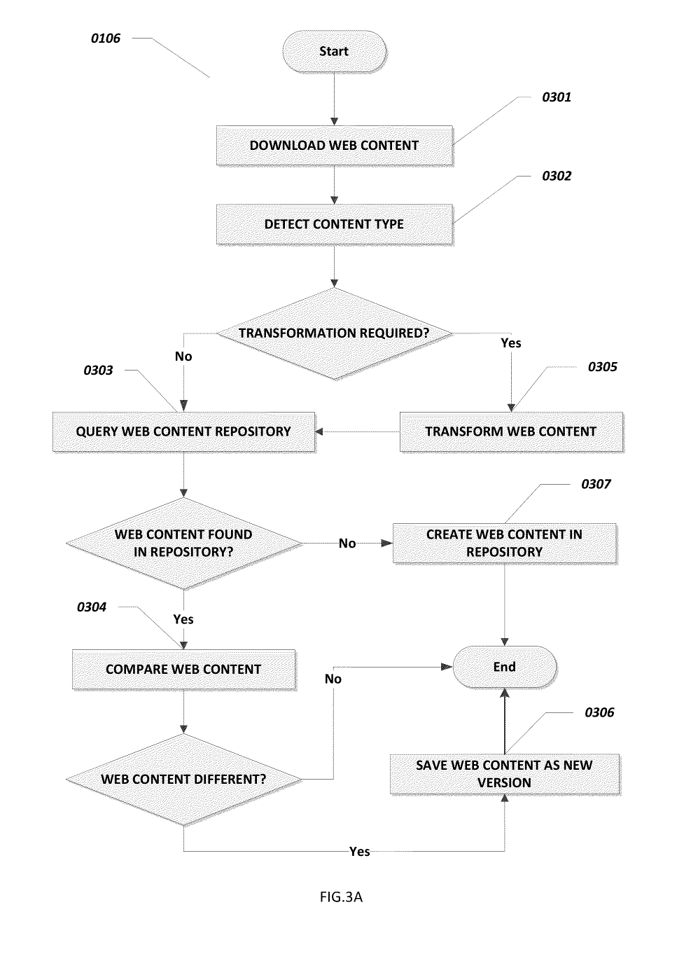

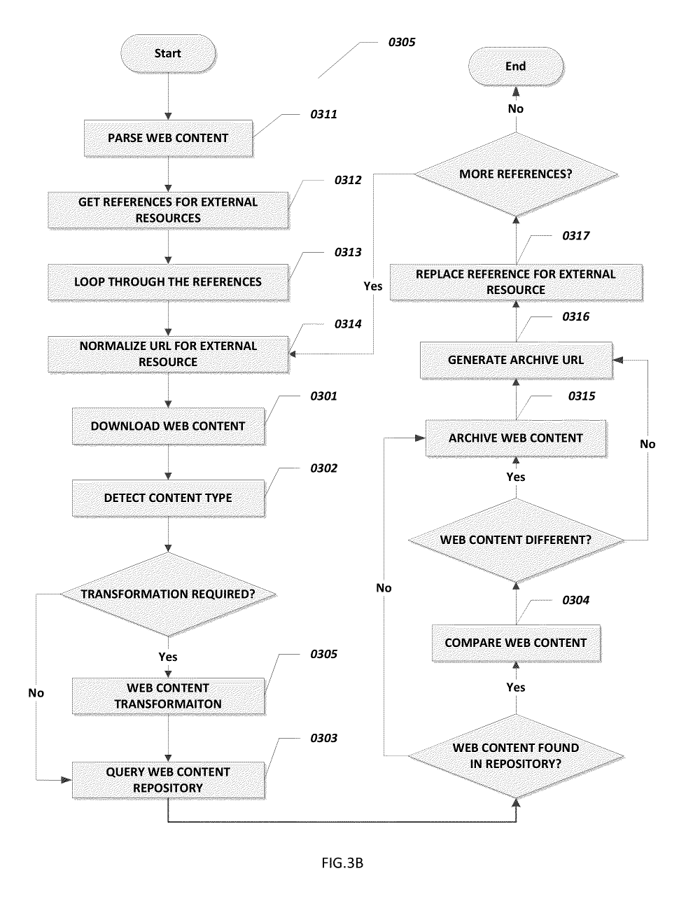

FIG. 2A is a flowchart illustrating from an end user perspective a high level process of getting web content histories by providing a resource URL for the content on the web. The first step is USER VISITS WEB CONTENT SERVICES 0201 where a user starts from a website where Web Content Services 0106 is hosted. On the website, the user is prompted with an input field where the user can enter a web content URL. Entering a web content URL is the second step USER INPUTS A WEB CONTENT URL 0201. In order to input a web content URL, the user must obtain an absolute URL for the web content that the user wants to look up for histories. A simple way to obtain a fully qualified URL is from a web browser, navigate to the webpage of interest, and copy the URL from the browser's address bar. For example, if you are interested in a used car on sale from Yahoo Auto, navigate to the car you are interested in from autos.yahoo.com. As you navigate through the webpages, the URL string in the browser's address bar changes reflecting the current web content displayed in the browser. Once the car of your interest is displayed in the browser window, you can copy the URL from the browsers' address bar, which would be something like “http://autos.yahoo.com/used-cars/mercedes benz-gl-cars01-3276695431155271511; ylt=AjH2CQ2eRCfR8l1fi13hkdpn61pH; vlv=3?sortcol=absoluterank&sortdir=do wn&location=Gaithersburg%2C+MD+20852&listingtype=used&model=gl&make=mercedes benz&dista nce=50&userdistance=4”. This URL uniquely identifies the used car that you are interested in. And you can save this URL for later use. You can copy and paste this URL into the browser's address bar and view the car days or months later as long as it's still available from Yahoo Auto. While this might not be a good example because when this used car is delisted from Yahoo Auto website, you may not want to view the car anymore. However, if for some reason you still want to view the car even after it's been sold or delisted from Yahoo Auto website, you can do so by launching a web browser, pointing to an application server that hosts Web Content Services 0106 and pasting the URL to the input field for web content URL and then click a button to submit the request. This action takes to Web Content Services 0106. Details of the internal working of the Web Content Services 0106 are covered in FIG. 3A and FIG. 3B. After the Web Content Services 0106 returns, the user is presented with a list of archive URLs as shown in step DISPLAY A LIST OF ARCHIVE URLS 0203. Each archive URL points to one version of the web content addressed by the given web content URL. Each version represents one revision of the web content since the publication of the web content on the network. Revisions may include but not limited to changes of text, styles, layout, icons, images, even functionalities.

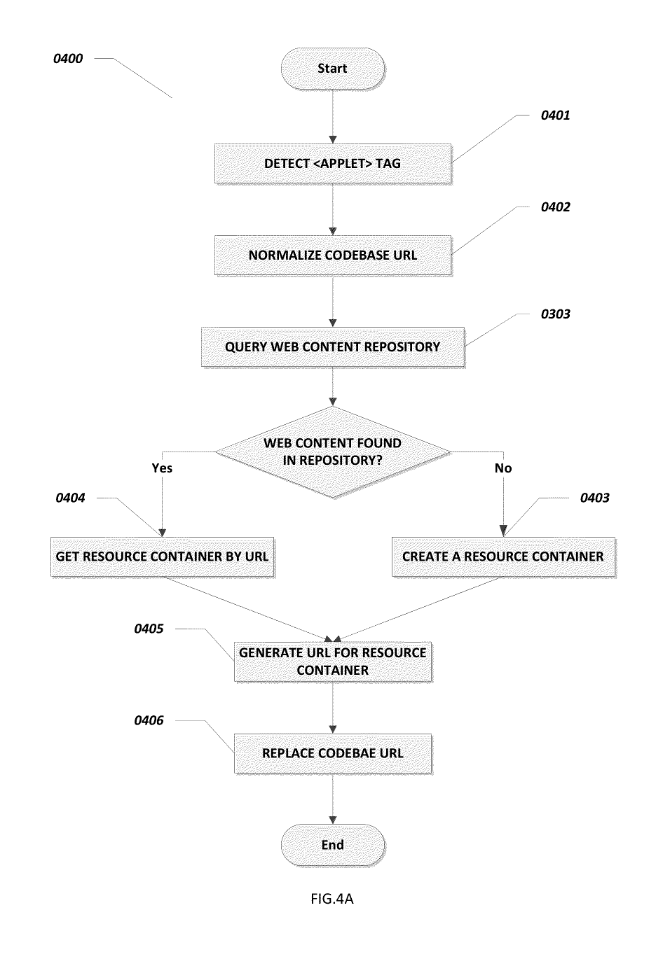

FIG. 2B is a flowchart illustrating from end user perspective a high level process of displaying a revision of the web content among a list of revisions. It starts from end user clicking an archive URL presented in the browser window, at the step USER PICKS A SYSTME URL 0211. The Web Content Services 01001 at the client side launches a new browser window at the step LAUNCH A BROWSER WINDOW 0212. In this step, Web Content Services 01001 also populates the browser window with the content of a revision of the web content archived in the Web Content Repository 0109. Archived content is downloaded from Web Content Services 0106. If the downloaded content has references to external resources such as JavaScript, cascading style sheet, browser plug-in etc. external resources are also downloaded from Web Content Services 0106. Then at the step REPLAY OF ARCHIVED WEB CONTENT 0213, the archived content is displayed without fidelity loss on the browser window in the same way as if it were served by the website that originally hosted and served the web content before archived in Web Content Repository 0109. Depending on implementations, the REPLAY OF ARCHIVED WEB CONTENT 0213 step may display two or more revisions side by side at the same time for comparison with the differences in two revisions highlighted in colors. When external resources include browser plug-ins where secondary resources are required at runtime, the requests for the secondary resources are sent to Proxy 0107 inside Web Content Services 0106 where secondary resources are requested from the original hosting website and then archived in Web Content Repository 0109 and then delivered to the browser plug-in at the client side. Details of the internal working of Proxy 0107 and the archiving of secondary resources will be covered in FIG. 4A and FIG. 4B.

FIG. 3A is a flowchart illustrating the internal process of Web Content Services 0106 when handling a request for web content histories. The process starts with an absolute URL for a resource on the web. The web content is the one that end user wants to check for histories of updates. The execution starts from the step DOWNLOAD WEB CONTENT 0301 which downloads the web content addressed by the given resource URL. This step opens an http or https or ftp connection to the website where the requested web content is hosted and served to the public. This step downloads the web content from the public website in the same way as if the end user is downloading the web content using a web browser directly. Due to the dynamic nature of most public websites and the differences between web browsers, different browsers may get different web content, especially HTML, JavaScript and CSS even when the exact same resource URL is provided. Since Web Content Services 0106 is running at the server side, the differences between browsers must be handled respectively so that the downloaded web content is the same as the one that user would see from the browser when he browses the web content directly using the browser. Also since the requested web content can be one of many types such as HTML page, image, JavaScript, cascading style sheet, or anything that can be addressed by an URL, we must detect the content type after successful downloading of the requested web content. This comes to the second step DETECT WEB CONTENT TYPE 0302. We must detect the content type because different content type may result in different treatment afterwards. For instance, if the content type is one of the image types such as JPEG, GIF and PNG, there is no need for parsing the downloaded web content since image files do not contain references for external resources. On the other hand, if the content type is HTML, JavaScript, CSS etc. the downloaded web content must be fed to a parser in order to find out references to external resources, because these content types may have references to external resource that contribute to the normal display of the web content in a browser window. Without archiving external resources, end user may experience loss of fidelity when the archived web content is replayed from a browser. After detecting the content type of the downloaded web content, the process checks whether the content type requires content transformation. If the web content requires transformation, the step TRANSFORM WEB CONTENT 0305 is executed. The transformation step transforms the downloaded web content before saving it into Web Content Repository 0109 so that it can be served and displayed to end user later on without loss of fidelity. The details of web content transformation are shown in FIG. 3B. This step may take significant amount of time to finish. From implementation perspective, it is a good idea to put this step into a separate thread of execution which can run independently from the main thread that handles requests from the clients. After transformation, the process goes on to the step QUERY WEB CONTENT REPOSITORY 0303. If the web content doesn't require transformation the process jumps directly to the step QUERY WEB CONTENT REPOSITORY 0303 which queries Web Content Repository 0109 for the existence of archived historical records. The query is performed using the provided resource URL as the key. If the query comes back with nothing, the execution goes to the step CREATE WEB CONTENT IN REPOSITORY 0307 which creates a new record in Web Content Repository 0109 for the given resource URL. Next time, when a client queries the historical records using the same resource URL, it is able to display this particular revision in the browser window. To replay a web content that might be modified, updated, removed or even deleted from the original website, archiving the web content is the only way. This step guarantees the archived web content can be replayed later on in the same way without the loss of fidelity as end user seeing it from his or her own browser window when browsing the web content from the hosting website. If the query for Web Content Repository 0109 comes back with a list of records, the execution goes on to the step COMPARE WEB CONTENT 0304 which compares the downloaded web content with the archived web contents identified by the list of records. This is to check whether the downloaded web content is different from what has been archived in the Web Content Repository 0109. This step helps Web Content Services 0106 decide whether a new version needs to be created in the Web Content Repository 0109 for the downloaded web content. If there is no difference, the process come the end. Otherwise, the execution goes on to the step SAVE WEB CONTENT AS NEW VERSION 0306 which saves the web content (transformed already if necessary) as a new version in the repository. At the end of the process, a list of archive URLs is constructed and returned to the client. Each archive URL represents a revision archived in the repository. They are all corresponding to the same resource URL that user provided at the beginning of the process.

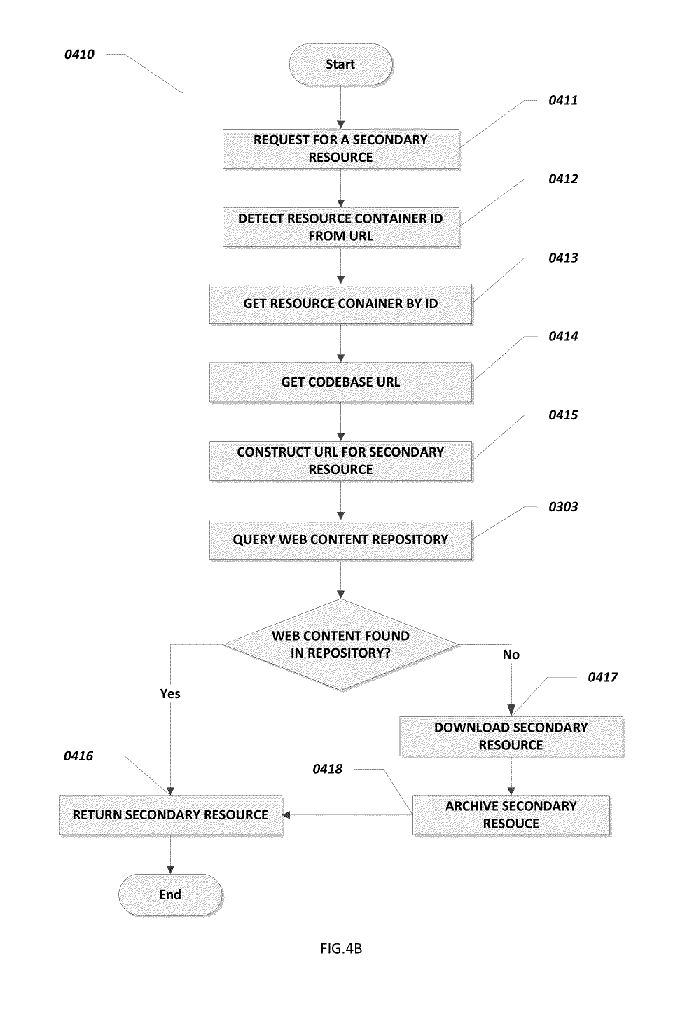

The transformation of web content is only executed when the web content may contain references to external resource. Examples of such web contents are HTML, JavaScript and cascading style sheets. If the content type of the downloaded web content does not contain references for external resource, for example images, video/audio files and business documents etc. there is no need for transformation. FIG. 5 shows a sample HTML page before and after transformation. The sample HTML page is the home page of a fake company addressed at “http://www.fakecompany.com/index.html”. The HTML page displays an image button on the browser. It has references to two external resources, one for the JavaScript file where the functioning of the image button is defined and implemented, and the other for the image on the image button. Before transformation, both external resources reside on the website at “http://www.fakecompany.com”. References for both external resources are in in the form of relative URL. The display and function of this sample HTML page depends on the existence of the static image file under the “images” folder, images/action.png, and the existence and correct format and implementation of the external JavaScript file under the “js” folder, js/action.js. Simply archiving the HTML page will not be able to reproduce the look and feel and functionalities of the web content. For instance, if action.png is not archived, the image button will show up missing the image from the HTML page when it is replayed in a browser.

Web content transformation resolves this issue by downloading and archiving not only the HTML page, but also the external resources referenced in the HTML page. The references are also translated from relative URLs to absolute URL pointing to files archived in the repository. The sample HTML page in FIG. 5 shows how references to the JavaScript file and the static image file are translated after the transformation. The static image file is downloaded from “http://www.fakecompany.com”, archived in Web Content Repository 0109 and assigned a web content object ID of “2345678901”. Similarly, the JavaScript file is also downloaded from “http://www.fakecompany.com”, archived in the Web Content Repository 0109 and assigned a web content object ID of “1234567890”. The HTML page addressed by a fully qualified URL “http://www.faky.company.com/index.html” can now be addressed by an archive URL “http://www.webcontenthistory.com/archive?id=0123456789” where “www.webcontenthistory.com” is the website where Web Content Services 0106 is hosted. When this archive URL is entered into the address bar of a browser, the browser window will request the archived web contents from Web Content Services 0106 at “http://www.webcontenthistory.com”. Since now the references to both external resources are pointing to resources on Web Content Services 0106, both external resources are available when the archived webpage is replayed from a browser. The look and feel as well as the functionalities of the webpage is preserved. End user will not be able to notice the differences between the web content served from “http://www.webcontenthistory.com” and the original web content served from “http://www.fakecompany.com”. More importantly, end users can still display the webpage addressed by the resource URL “http://www.fakecompany.com/index.html” even after the webpage has been removed from “http://www.fakecompany.com”, because once archived, web contents addressed by resource URLs are delivered from “http://www.webcontenthistory.com”. Additionally, users can a list of revisions made to the web content addressed by the resource URL “http://www.fakecompany.com/index.html”. With the content versioning capabilities built into the Web Content Services 0106 and Web Content Repository 0109, a different version of the HTML page addressed by the resource URL “http://www.fakecompany.com/index.html” and a different version of icon file referenced by “http://www.fakecompany.com/images/action.png” will be archived in the Web Content Repository 0109, if the original icon file had been updated to a different content on the original website. This enables the end users for browsing and comparing the entire history of the changes made to the web content.

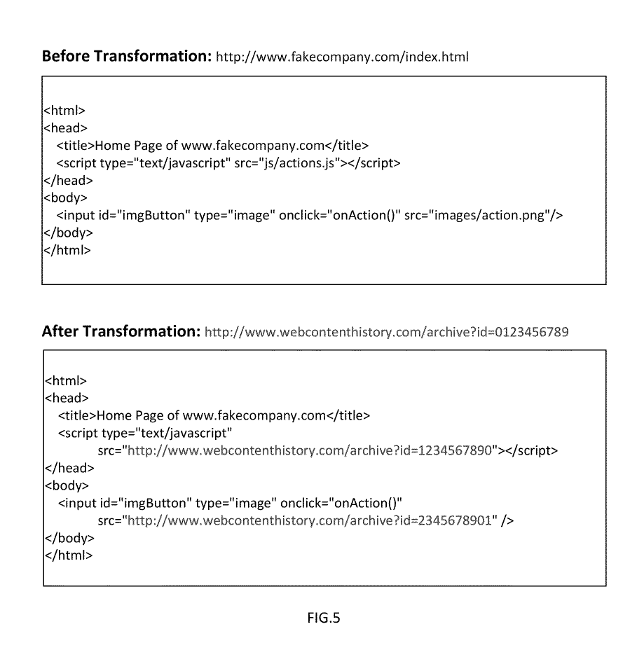

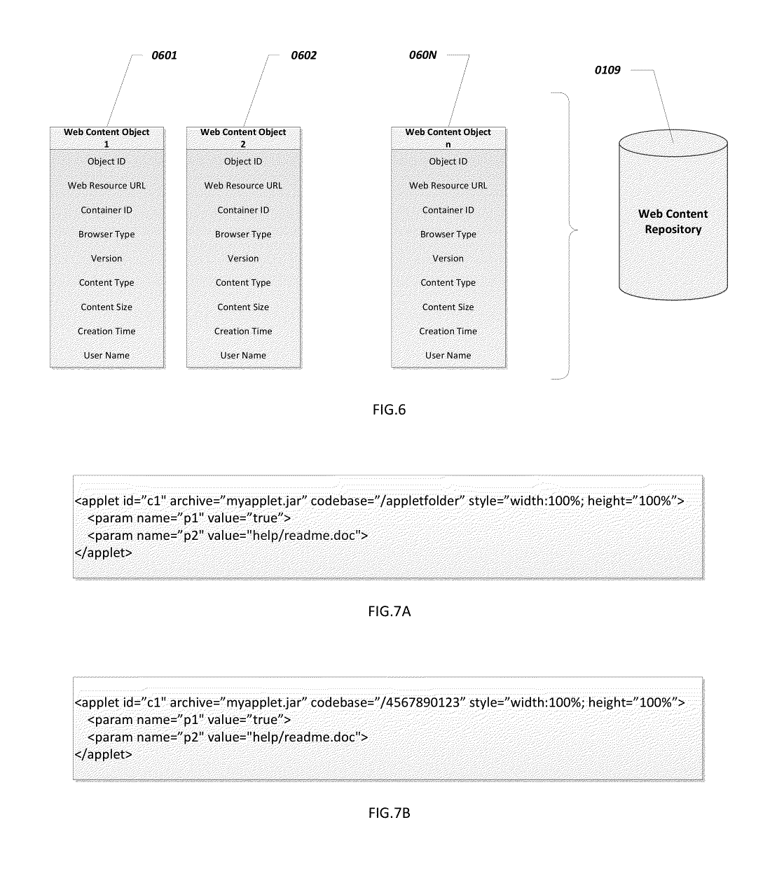

From the database perspective, the cross reference between a resource URL such as “http://www.fakecompany.com/index.html” and an archive URL for instance “http://www.webcontenthistory.com/archive?id=0123456789”, and the versioning of the changes to web contents over the time can be established by one-to-many relationship in the database tables of the underlying content management system where a resource URL string is the key index to one or many archive URLs. Given a resource URL string for a resource on the web for instance “http://www.fakecompany.com/index.html”, Web Content Services 0106 can always query the Web Content Repository 0109 to get back one or many archive URL strings that identify different revisions of the archived web content in the Web Content Repository 0109. The structure of the database table will be described in detail in FIG. 6.

FIG. 3B illustrates the process of web content transformation. The process starts with a file or a stream of the downloaded web content that requires content transformation. The first step is PARSE WEB CONTENT 0311 which loads the web content file or stream into a web content parser. Depending on the content type, different parser might be required. For instance, if the web content is of HTML type, the web content is loaded into a HTML parser. If the web content is of JavaScript type, the web content is loaded into a JavaScript parser. Regardless what parsers are used, a list of references for external resources are expected from the parser. The process goes on to the second step GET REFERENCES FOR EXTERNAL RESOURCES 0312 where a list of references to external resources is obtained from the parser. At the next step LOOP THROUGH THE REFERENCES 0313, the process loops through the list to examine each external resource. At the step NORMALIZE URL FOR EXTERNAL RESOURCE 0314, the resource URL for the external resource is normalized. URL normalization is a process that translates a relative URL into an absolute URL. Use of relative URLs for references to external resource is very common HTML pages, JavaScript files and CSS files. An example of relative URL is the reference to “images/action.png” in FIG. 5. Since the index.html file is on the same level of the “images” folder, the website that serves the browser's requests knows the relative location of “images/action.png” to index.html. From the context of index.html, relative “images/action.png” is the same as the absolute URL “http://www.fakecompany.com/images/action.png”. Use of relative URLs for external resources makes HTML pages smaller in size and potable from applications to applications. However, from the perspective of web content history management, translating a relative URL into an absolute URL saves the hassle for Web Content Services 0106 and Web Content Repository 0109 to remember and reconstruct the page context at the replay of the HTML page, given that Web Content Services 0106 is supposed to provide services for many web contents from many public websites. Actually, all URLs for archived web contents are stored in Web Content Repository 0109 in the form of absolute URL. The need for the normalization of URLs becomes obvious in the next step DOWNLOAD WEB CONTENT 0301 which downloads the external resources addressed by the resource URL. At this step, Web Content Services 0106 uses an absolute URL to request the web content from a public website. Without the normalization, Web Content Services 0106 must remember the page context where the external resource is referenced from. After successful download of the web content, the process must detect the content type of the web content at the step DETECT CONTENT TYPE 0302. Detecting the content type is necessary since not all content types require transformations. Image content types, for instance do not require transformations, thus web content of these types can be archived directly into Web Content Repository 0109 without transformations. On the other hand, content types that may contain references to external resources, transformations are required. From implementation perspective, transformation is a recursive process that web content transformation can be executed over and over again if web content contains reference to another web content that may contain references to yet more external references. If the downloaded web content requires transformation, the process goes on to the step WEB CONTENT TRANSFORMATION 0305, and then to the step QERY WEB CONTENT REPOSITORY 0303. If the downloaded web content doesn't require transformation, the process jumps directly to the step QERY WEB CONTENT REPOSITORY 0303 which queries Web Content Repository 0109 for the existence of the normalized resource URL for the external resource. This step comes back with a list of web content objects with each representing one revision of the web content addressed by the resource URL. If an empty list or nothing comes back from this step, it means the web content has not been archived in Web Content Repository 0109. In this case, the process jumps to the step ARCHIVE WEB CONTENT 0315 which saves the web content (transformed if necessary) into the repository and create a new web content object in the database. If the resource URL is found in the repository, the process goes on to the step COMPARE WEB CONTENT 0304 which compares the web content archived in the repository with the content just downloaded. If the two are different, the process goes on to the step ARCHIVE WEB CONTENT 0315 which save the downloaded web content (transformed if necessary) into the repository, and create a new revision of the web content object in the database. If the two web contents are the same, the process jumps to the step GENERATE ARCHIVE URL 0316 where an archive URL is generated from the object ID of the web content object. An archive URL addresses a specific revision of the web content archived in Web Content Repository 0109. The generation of an archive URL requires not only the object ID of a web content object but also the context that the web content will be hosted and served. As an example, the reference URL to “images/action.png” in FIG. 5 is translated to “http://www.webcontenthistory.com/archive?id=2345678901” which is an archive URL addressing a revision of the icon file archived in Web Content Repository 0109. “2345678901” is the object ID that identifies the archived icon file, “archive” is the application path that serves archived web contents, and “http://www.webcontenthistory.com” is the website where Web Content Services 0106 is hosted. This example uses an absolute URL for archive URLs. Absolute archive URL guarantees that the archived web contents are portable to other environments. The archived HTML page with absolute archive URLs addressing external resources allows the display of the HTML page anywhere in any environment as long as the hosting application “http://www.webcontenthistory.com/archive” is running and available on the web. If portability is not a concern, the archive URLs can also be generated in the form of relative URL, “/archive? id=2345678901” which saves the storage space for archived web contents. With an archive URL obtained, regardless of absolute or relative form, the transformation process needs to replace the original resource URL with an archive URL. Replacement happens at the step REPLACE REFRENCE FOR EXTERNAL RESOURCE 0317. Again using FIG. 5 as an example, the reference to action.png is switched from “images/action.png” to “http://www.webcontenthistory.com/archive?id=2345678901”. The replacement of URLs for external resources guarantees that when index.html is replayed in a browser, the PNG file referenced is available from the website where Web Content Services 0106 is hosted regardless whether the PGN file has been modified, updated or even removed from “www.fakecompany.com”. After the replacement of URLs, the process checks whether there are more references for external resources. If there are more references not being processed, the process goes back to the step NORMALIZE URL FOR EXTERNAL RESOURCE 0314 again. Otherwise, it comes to the end of the transformation process.

Obviously the recursive web content transformation process cannot go on forever. The recursive invocation of the transformation procedure must be terminated at some point so that the computer system won't fall into a seemingly endless loop. A good termination point must be decided at the individual implementations of the transformation procedure. A good termination point would be at a secondary web content (HTML page, css, javascript etc) that doesn't contribute to the look & feel of the web page referenced by a resource URL that the user provided for web content archiving. A secondary web contents are those referenced as external resources in the web content that is referenced by a resource URL that the user provided for web content archiving. Some types of web contents are good termination points by nature, for example images, audio/video files because they do not require parsing for external resources. However, not all secondary web contents are good termination points for terminating the web content transformation procedure. For example, if an end user requests the archiving of http://www.fakecompany.com/demos.html which contains a <IFRAME>HTML element that references http://www.fakecompany.com/productdemo.html, then productdemo.html page is not a good termination point because this page directly contributes to the look & feel of the user requested page. Without downloading and transforming productdemo.html, the demos.html page would not look right when it is replayed as historical record from the Web Content Repository 0109. However, if the demos.html contains a <A>HTML element which links to another page aboutus.html for example, aboutus.html could be a good termination point because without downloading and transforming it, the look & feel of demos.html would not be affected when replayed as historical record from the Web Content Repository 0109, of course except users click the link. When it is decided that aboutus.html is a good termination point, the web content transformation procedure will not download the resource and invoke the transformation procedure on it.

Capturing data requested from HTML is straight forward. If we parse out the HTML pages and other contents that may require transformation and gets a list of resource URLs referencing external resources, we can download and archive the resources on the web addressed by the resource URLs. For instance, if a webpage has an anchor element referencing an external resource, <a href=“http://www.fakecompany.com/aboutus.html”>, we can always get the value of the “href” attribute from a HTML parser, and then use the URL to download the content of aboutus.html from www.fakecompany.com.

However, capturing dynamic data requested from within a browser plug-in is a more challenging. Java Applet and ActiveX control are typical browser plug-in technologies upon which many browser plug-in applications have been created. What makes browser plug-ins popular is because plug-ins comes with sophisticated user interface implementations and complex business logics, and they can be embedded in webpages. They look like part of the browser window once shown. The HTML tag for hosting Java Applet plug-ins in a webpage is the <applet>tag, and the one for hosting ActiveX controls in a webpage is the <object>tag. Although Java Applet and ActiveX control support <param>tags where browser plug-in integrators can use to expose URLs for external resources, in the real world however, there is no guarantee that all external resources that the browser plug-in application requires are exposed via <param> tags. A browser plug-in may well hard code the URLs for some external resources that it requires at runtime in its implementations. In the case of Java Applet, a browser plug-in depends on the “codebase” attribute to locate external resources deployed at the location specified by the “codebase” attribute. For example, FIG. 7A illustrates a HTML code snippet with a Java Applet embedded. The code snippet shows that a Java Applet is to occupy the entire client area (100% width and 100% height) specified by the container of the <applet> tag, and the Java Applet's binary, myapplet.jar resides in the folder specified by the “codebase” attribute, i.e. within the folder named “appletfolder” on the application server where the applet is deployed. The web browser that the Java Applet is embedded in will download myapplet.jar from the application server and invoke code implemented in myapplet.jar for initializations. The Java Applet takes two initialization parameters, with the first parameter “p1” a boolean type with a default value set to true, and the second parameter “p2” an URL type with the value set to “help/readme.doc”. The setting of the value for the second parameter assumes that “/appletfolder/help/readme.doc” resides on the application server where the applet is deployed. More precisely, the setting of the “codebase” attribute tells the Java Applet that all fixed content it requires from the application server side should be residing under the folder named “appletfolder” on the application server where the applet is deployed, unless an absolute URL is specified. With this assumption, a Java Applet may request any fixed content deployed under the “appletfolder” without exposing the URL for the fixed content via the <param> tags. For instance, the Java Applet code myapplet.jar may request a binary file named module.bin from the application server after the completion of the applet initialization. The request will succeed as long as a file named module.bin does exist under the “appletfolder” folder. In this case, module.bin is not specified in the initialization parameters. The myapplet.jar can hard wire the name in its implementations as long as it knows where the file resides on the application server relative to the value specified by the “codebase” attribute. Needless to say, the user session that the web browser carries for loading the HTML page with the Java Applet embedded must have the permission to access to “appletfolder/module.bin” from the application server. Otherwise, a HTTP communication error will arise from the Java Applet.

From web content archiving perspective, all HTTP traffic between a browser and the application server must be captured so that when the archived webpage is replayed, the webpage will be able display all contents as if they are served from the original application server. By parsing the HTML content where the Java Applet is embedded, we can get hold of the information that appears at the construction of the Java Applet, such as the URL for “myapplet.jar”, and the URL for “help/readme.doc” with the help of the value specified at the “codebase” attribute. However, we have no idea about “module.bin” since it's never been exposed anywhere. This means “module.bin” will not be captured at the time when the webpage is parsed and transformed. Since “module.bin” may contain important data or program for the display of the Java Applet, missing this file in the web content archive means when the archived webpage is replayed, the embedded Java Applet will not display data correctly, or for the worse the Java Applet may not function correctly. This invention introduces a mechanism for archiving resources that are not specified via the initialization parameters of a browser plug-in, but requested from within a browser plug-in via hard coded resource URLs. One embodiment of this invention enables the archiving of resources requested from within a browser plug-in via hard coded resource URLs that are not exposed at the list of initialization parameters but located under the folder location specified by the “codebase” attribute.

It is desirable to introduce the concept of secondary resources in order to capture the resources requested from within a browser plug-in via hard coded resource URLs that are not exposed from the initialization parameters. A secondary resource is different from the regular resource on the web. Like regular resources, a secondary resource is still a resource on the web addressable by an URL. But the URLs for secondary resources may or may not be exposed anywhere. The URLs for secondary resources are private to the implementations of the browser plug-in. They are hard coded into the implementations, in the form of absolute URL, or in the form of relative URL relative to the folder location specified by the “codebase” attribute. The secondary resources can be a file stored under the folder specified by the “codebase” attribute, or they can be services served from a 3^{rd} party web server. They can be anything that the browser plug-in requires at runtime. From web content archiving perspective, there is no way to delegate the requests for secondary resources at the time of parsing and transforming the HTML page where the browser plug-in is embedded. The only way to track the secondary resources is when the HTTP requests are actually being made. Using the example above, to archive “module.bin” under the “appletfolder” folder, we have to wait till the Java Applet actually makes the request for “module.bin”, because the URL that addresses “module.bin” is hard coded in the implementations of the Java Applet.

However, when an archived webpage is served from a web content archiving server, if the webpage has a browser plug-in embedded in, the browser plug-in will make requests to secondary resources that are not yet archived in the web content archiving repository. The browser plug-in instance will not be able to reproduce the content display if the secondary resources it requires are not available.

The use of the “codebase” attribute would help to solve this problem. By specifying a special value to the “codebase” attribute at the time of transforming the webpage where a browser plug-in is embedded, we can make sure all requests for the secondary resources are made to a proxy that is part of the web content archiving facilities. The proxy then delegates the request to the hosting website where the secondary resources are originally hosted. Since all resources are addressed by URLs, a mechanism is desirable to link the proxy URL and the original resource URL addressing the secondary resource hosted on the original web server.

This invention introduces the concept of resource containers for secondary resources that reside under the folder location specified by the “codebase” attribute. A resource container is a persistent object in the database, similar to the web content object. Every resource container object has a unique object ID associated with it. Like the web content object, every resource container object also has a resource URL addressing the folder where a browser plug-in would request secondary resources from. The difference between the web content object and the resource container object is that a resource container object may have one or more web content objects associated with it in the object containment type of relationship. We can use a resource container to contain all secondary resources that a browser plug-in requires at runtime. The resource container object serves as a proxy for delegating requests for secondary resources. FIG. 7B shows the transformed HTML of the HTML snippet illustrated in FIG. 7A. The “codebase” attribute of the Java Applet, after transformation is given a value for a resource container “/4567890123” which at the database level is associated with the normalized value of the original resource URL for codebase “/appletfolder”. This association between a resource container and the original resource URL for codebase enables Web Content Services 0106 to look up the original website where this Java Applet is hosted. FIG. 7B is simply an exemplary transformation. When this transformed HTML snippet is replayed from a browser, the request for myapplet.jar will be made via archive URL “/4567890123/myapplet.jar” from within the browser plug-in, and the request for help/readme.doc will be made via archive URL “/4567890123/help/readme.doc”. And the secondary resource module.bin will be requested via archive URL “/4567890123/module.bin” from within the browser plug-in. A more sophisticated transformation might be desirable if we want to archive the myapplet.jar and readme.doc at the time of transformation. In this case, the reference to “myapplet.jar” is transformed to “archive?id=3456789012”, and the reference to “help/readme.doc” is transformed to “archive?id=5678901234”.

FIG. 4A illustrates a flowchart for transforming a HTML page with Java Applet embedded in. Although specific about Java Applet, the process illustrated in this flowchart applies to other types of browser plug-ins. The process starts with the step DETECT <APPLET>TAG 0401 which parses out <applet>tags from a HTML content. The next step is NORMALIZE CODEBASE URL 0402 which normalizes the URL specified for the “codebase” attribute. Normalization of codebase URL translates the value specified for the “codebase” attribute into an absolute URL that includes the page context information. If the HTML code snippet in FIG. 7A is embedded in a HTML page under “http://www.fakecompany.com/docviewer” for instance, the normalized codebase URL becomes “http://www.fakecompanv.com/docviewer/appletfolder”. The normalized codebase URL is then used as key to query Web Content Repository 0109 in the step QUERY WEB CONTENT REPOSITORY 0303. The query to the repository makes sure whether a resource container object already exists in the repository. If a resource container found in the repository, the process goes on to the step GET RESOURCE CONTAINER BY URL 0404 which retrieves an existing resource container object from the repository. On the other hand, if no resource container found in the repository, the process goes on to the step CREATE A RESOURCE CONAINER 0403 which creates a new resource container in the repository, and associate the new resource container with the normalized codebase URL. Next time when the same codebase URL is used as key to query the repository this resource container object will be instantiated and returned to the caller. The next step is GENERATE URL FOR RESOURCE CONTAINER 0405 which generates an archive URL for the resource container. The next step is REPLACE CODEBASE URL 0406 where the original codebase URL is replaced by the archive URL for the resource container. Afterwards the process goes on to the end. FIG. 4A is simply an exemplary process that demonstrates the transformation of the HTML that contains a browser plug-in. During this exemplary process, no downloading and archiving of secondary resources is happening because the downloading and archiving of secondary resources are postponed to the runtime when the archived HTML is replayed. Alternative process might be desirable to archive the non-secondary-resources such as myapplet.jar and help/readme.doc in FIG. 7A during the process of transformation of the HTML page so that the replay of the archived HTML doesn't involve archiving of those resources thus having a better performance in response time.

FIG. 4B illustrates a flowchart for archiving secondary resources. This process gets executed when an archived HTML page is replayed and the embedded browser plug-ins making HTTP requests for secondary resources. The process starts from the step REQUEST FOR A SECONDARY RESOURCE 0411 where Web Content Services 0106 waiting for requests for secondary resources. Since the URLs for secondary resources all have object IDs of resource containers that have been generated during the process of web content transformation, the next step is DETECT RESOURCE CONTAINER ID FROM URL where the resource container ID is extracted from the request URL. With a resource container ID, the process goes on to the next step GET RESOURCE CONTAINER BY ID 0413 to query Web Content Repository 0109 for resource container object. Once a resource container object is obtained, we can figure out a lot of information about this container, including but not limited to the normalized codebase URL which can be obtained at the step GET CODEBASE URL 0414. The normalized codebase URL contains the information on where the secondary resource is originally hosted. Since the archive URL for the secondary resource contains not only the ID for the resource container but also the name of the secondary resource, combining the normalized codebase URL with the name of the resource, we can obtain the fully qualified URL addressing the secondary resource on the web where the secondary resource is originally located and served. An absolute URL for the secondary resource can be constructed at the step CONSTRUCT URL FOR SECONDARY RESOURCE 0415. With the sample HTML snippet in FIG. 7B, the request for secondary resource module.bin that is made from with the Java Applet will have an archive URL like “http://www.webcontenthistory.com/4567890123/module.bin”. The normalized codebase URL looks like “http://www.fakecompany.com/appletfolder”. Combining information in both URLs, we can obtain the absolute URL addressing the module.bin hosted on the original website: “http://www.fakecompany.com/appletfolder/module.bin”. Using this resource URL for the secondary resource, the process queries the Web Content Repository 0109 for existence of the web content object at the step QUERY WEB CONTENT REPOSITORY 0303. If the web content object exists, the process simply retrieves the content from Web Content Repository 0109 and then streams the content back the secondary resource to the client. If the web content object does not exist in the repository, the process downloads the resource using the resource URL at the step DOWNLOAD SECONDARY RESOURCE 0417, and then archives the downloaded resource in the repository at the step ARCHIVE SECONDARY RESOURCE 0418, and then streams back the resource back to the client. The step ARCHIVE SECONDARY RESOURCE 0418 may involve content type detection and content transformations depending on the actual implementations. The step may also involve versioning of secondary resources if so required by the implementation of Web Content Services 0106.

Nevertheless, considering a browser plug-in may request anything from anywhere on the web, not limited to resources under the folder specified at the “codebase” attribute, tracking the requests for the secondary resources can be still challenging. What if a browser plug-in makes a request to an arbitrary secondary resource that is not hosted on the web server where the browser plug-in is hosted? How would a web content archiving server know such requests ever taking place? A web content repository backed web browser would be the ultimate solution. Since all requests for web resources are coming either from a web browser itself or from browser plug-ins embedded in the browser, a new browser with the built-in connections to Web Content Services 0106 would be desirable. Every http/https or ftp request initiated from within the browser will be sent to Web Content Services 0106 for archiving, this is regardless of where a resource URL is activated from. A user of the browser can type in an URL for a web resource from the address bar. The web content addressed by the resource URL gets displayed in the browser window, at the same time the resource URL is sent to Web Content Services 0106 for archiving the resource addressed by the resource URL. Or a user can select a link on a webpage displayed within the browser in order to jump to another webpage. The new webpage gets displayed in the browser window, at the same time the resource URL addressing the new webpage is sent to Web Content Services 0106 for archiving. Or when the browser is instantiated with a resource URL, the URL is sent to Web Content Services 0106 for archiving the web content addressed by the URL. Or when a browser plug-in embedded in a webpage sends a GET HTTP request for a resource (any resource from anywhere on the web), the new browser captures the resource URL and then sends the URL to Web Content Services 0106 for archiving. This is done without the interventions from the users of the browser. From end users' perspective, the new browser behaves exactly the same as any other browsers. A web content repository backed web browser enables the archiving of resources on the web as users browsing the web.

Finally, FIG. 6 illustrates a stack of exemplary Web Content Object 0601 through 060N in Web Content Repository 0109. Each Web Content Object identifies a version of web content archived in Web Content Repository 0109. Each Web Content Object has a few attributes describing the archived web content. Following is an exemplary list of attributes for web content object:

a) “Object ID” attribute uniquely identifies the web content object within Web Content Repository 0109. Object ID is a string that serves as a key to access a web content object and the content archived in Web Content Repository 0109. Object ID has one-to-one correspondence with the archived content. Also, Object ID can used to load other attributes of the web content object.

b) “Web Resource URL” attribute is an absolute URL addressing a resource on the web. “Web Resource URL” uniquely identifies a resource on the web. A specific resource on the web may undergo updates or deletion, the URL never changes. Different URL is considered different resource on the web. From database perspective, resource URL has one-to-many relationship with object IDs. One object ID must be associated with a resource URL. However, two different object IDs are likely to be associated with the same resource URL. In the one-to-may relationship, each object ID represents an update or revision on the content of the resource. This relationship enables us to use a resource URL as a key to get a list of revisions of the web content that are addressed by the same “Web Resource URL”. The value for this attribute must be an absolute URL with the inclusion of information such as the protocol, the domain name, port number (if not the default 80), application path and the query parameters etc.

c) “Container ID” attribute specifies the object ID of a resource container for secondary resources. Only with a valid “Container ID”, the web content object can be considered a secondary resource. For a regular resource, this field is left empty.

d) “Browser Type”. Due to the differences among browsers and the implementations of public websites serving different browsers, different web contents might be delivered to different browsers even if the exact same resource URL is used to address the resource. Web contents delivered for one type of browser may not display normally from a different type of browsers. To cover the dependency on browser types, web content object must have this field to indicate which browser the archived web content is for. If the web content for a particular browser type is not currently available in the repository while web contents for other browser types have been archived in the repository, it is up to the implementation of Web Content Services to prompt the user to replay the web content archived for the browser type different from what the user is currently using.

e) “Content Type” attribute indicates the content type of the archived web content. Each web content must have a content type. Content type is obtained from the original website delivering the web content. Content type is an important factor for Web Content Services 0106 to compare web contents for versioning. If content types are different, downloaded web content shall be archived as a new revision in the repository. Content type is also important for Web Content Services 0106 to deliver archived web content to the client. Content type will be specified in the HTTP header of the HTTP data stream.

f) “Content Size” attribute is another important factor for web content comparison. This attribute indicates the raw file size prior the web content transformation. It is the file size of the web content right after the downloading from a public website. Since the transformation process changes the size of the web content, this attribute stores the original file size for comparisons with the updated web content. Different content size indicates that the downloaded web content has be updated from the website where the web content is hosted thus shall be archived as a new revision in the repository.

g) “Creation Time” attribute indicates the time when the web content is archived in the repository. Newer revisions must have later creation time in the repository. By looking at the “Creation Time” attribute, users can capture the evolvement of the web content over the time. The value of this attribute also provides a timestamp for web contents that have no time associated with them.

h) “User Name” attribute is an optional attribute. This attribute indentifies the user who initiated the archiving of a web content revision. The implementations of Web Content Services 0106 can use this attribute to implement privacy features that help users to keep web content histories private to themselves. This attribute can be left empty. Without a user name associated with the archived web content, the web content will be treated as public. The introduction of the “User Name” into the system is instrumental to the implementation of a change notification feature where registered users get notifications, such as emails automatically when a specified web page has been modified by the owner of the web page. Change notifications can be accomplished by establishing one-to-many relationship between a resource URL and user names or IDs, and when the content change has been identified by the system for a particular resource URL, user names or IDs can be looked up with the resource URL from the database and all users who have registered to watch the web content identified by the resource URL get notified by the system.

Resource container object is a special type of web content object. It has all the attributes that a regular web content object has. Only the values for some of the attributes are different. By looking at those values, Web Content Services 0106 can decide whether a web content object is actually a resource container object or not. For example, “Browser Type”, “Version”, “Content Type” and “Content Size” attributes do not really mean much to a container. They can be left empty when a resource container object is being created.

As shown in FIG. 6, a web content object has various attributes describing a web content archived in the repository. However, the web content itself is missing from the list of attributes. How do we locate a web content from a given web content object? This is a very important question in the field of content management. There are two different approaches to this question. The first approach is to have a BLOB (Binary Large OBject) field in the table for web content objects. The BLOB field serves as the storage for the web content. A web content object carries everything from the attributes to the content. The advantage of this approach is to let the database engine to handle the attributes and the content all together. There is no need to develop code to handle them separately. However as the number of records growing bigger and bigger, people starts to see significant degradations of performance at storing and retrieving data from the database due to large storage requirement for the database table. The second approach is to let database manage the attributes as shown in FIG. 6, while letting the computer file system manage web contents in the form of disk files. In this approach, extra code must be written to link the two. For example, given an object ID, we need to be able to locate the web content that the web content object is associated to. And vice versa, given a web content file in the repository, we need to be able to get the web content object from the database. The advantage of this approach is to leverage what the database is good at and what the file system is good at, without burdening the database with large amount of data. No BLOB field is needed in the table for web content objects. Degradation of performance from the database engine can be minimized. Another advantage of the second approach is that extensions to disk space are widely available from many storage vendors. By applying one of the storage solutions, disk space seen as unlimited from the perspective of Web Content Services 0106. There is no need to rely on database to provide extensions to disk space.

The second approach normally requires putting encrypted information into the object ID which provides pointers and indexes for locating a file on the file system.

Finally, a new web browser would be desirable as a front end tool to initiate the archiving process at the backend. With a web browser that is capable of sending archiving requests to a specified web content services, web contents get automatically archived at the server side as the users of the web browser navigate through the Internet or corporate intranet. Since it is the responsibility of the web content services to parse the HTML and other contents that may contain URLs for external resources, it is only necessary for the web browser to send URLs to the web content services as the users navigate through the web. To limit the number of requests to the back end for archiving, it is only necessary for the web browser to send archiving requests when: i) user typing an URL into the address bar of the browser; ii) browser instantiated with an URL; iii) user dragging an URL link from the desktop and dropping it to the browser; iv) an embedded browser plug-in making a request for secondary resources. It is unnecessary for the browser to send everyone and all URLs that it parses out of a HTML page to the web content services given the potential of large number of such embedded URLs and the performance degradation to the browser program due to archiving activities. Such web browser eliminates the need for end users to go to a web content archiving website for archiving the web contents. Copying and pasting the resource URLs from a web browser to another webpage becomes unnecessary.

To make the new web browser useful in both Internet and corporate intranet environments, the new browser may allow users to specify the web content services that they want to use to archive the web contents. And to avoid privacy concerns, the new browser may allow users to enable/disable the archiving feature so that once disabled, no archiving requests will be sent to the web content services.

What is claimed is:

1. A method for archiving resources on a network and displaying the contents of archived resources comprising:
Addressing a resource on the network with an URL;
Addressing an archived resource with an archive URL that identifies single revision of the content of the resources on the network addressed by the above said resource URL;
Providing a user driven process for archiving contents of resources on the network;
Providing a very large repository with the capacity of up to the size of all contents of the entire network including but not limited to the world-wide-web;
Providing a function for displaying the contents of the archived resources;
Providing a function for sending notifications to end users who are interested in receiving notifications for content changes from the contents addressed by resource URLs;

2. The method according to claim 1 wherein said user driven process for archiving resources on the network comprising user interface for end users to enter and submit resource URLs for archiving the contents of the resources addressed by the user provided resource URLs, and the contents of the resources addressed by the resource URLs referenced inside;

3. The method according to claim 1 wherein said user driven process for archiving resources on the network further comprising one or more of the following:
Function for downloading resources from the network;
Function for detecting the content type of the downloaded resources;
Function for deciding whether the downloaded resource requires content transformation;
Function for transforming the contents of the downloaded resources for later display;
Function for querying said very large repository according to claim 1;
Function for comparing the downloaded resource with the archived resources for deciding whether the downloaded resource requires saving into said very large repository according to claim 1;
Function for saving the downloaded and optionally transformed resources into said very large repository according to claim 1.

4. The content transformation function according to claim 3 further comprising one or more of the following:
Function for parsing the content of a resource in order to identify and extract embedded URLs for external resources;
Function for normalizing URLs, which translates an URL from relative form to absolute form;
Function for downloading resources from the network;
Function for detecting the content type of the downloaded resource;
Function for deciding whether the downloaded resource requires content transformation;
Function for saving the downloaded and optionally transformed resources into said very large repository according to claim 1;
Function for generating archive URLs;
Function for translating a resource URLs to the corresponding archive URL;
Function for replacing resource URLs embedded in the content with the corresponding archive URLs;
Function for querying said very large repository according to claim 1;
Function for comparing the downloaded resource with the archived resources for deciding whether the downloaded resource requires saving into said very large repository as a new revision of the archived resources;
Function for invoking the transformation function on the content of a resource downloaded from the network;

5. The content transformation function according to claim 4 comprising a mechanism for terminating the recursive invocation of said content transformation function;

6. The method according to claim 1 wherein said user driven process for archiving resources on the network further comprising function for capturing and archiving resources requested from within browser plug-ins through resource URLs that may or may not be publicly available from the content wherein the browser plug-in is embedded;

7. The method according to claim 1 wherein said function for displaying the contents of archived resources comprising one or more of the following:
Function for listing a portion or all revisions of the archived resources associated with a specified resource URL;
Function for end user to select one or more revisions from a list of revisions of the archived resources;
Function for displaying the content of a specific revision of the archived resources to end users;
Function for visually comparing the contents of 2 or more revisions of the archived resources;

8. The function for displaying the content of a specified revision of the archived resources according to claim 7 further comprising function for marking up the content of the archived resource with a timestamp representing when the resource is archived into said very large repository according to claim 1;

9. The method according to claim 1 further comprising one or more of the following:
Function for retrieving a list of archive URLs from said very large repository according to claim 1 provided a resource URL;
Function for delivering the list to clients;
Function for retrieving the content of an archived resource from said very large repository according to claim 1;
Function for delivering the retrieved content to the clients;

10. The method according to claim 1 further comprising functions for keeping changes to the content of a resource addressed by a resource URL private to users who initiated the archiving of the content of the resource;

11. A web content management system comprising:
Addressing a resource on a network with an URL;
Addressing an archived resource with an archive URL that identifies single revision of the content of the resource on the network addressed by above said resource URL;
Providing a very large repository with the capacity of up to the size of the contents of the entire network including but not limited to the world-wide-web;
Providing a function for archiving resources on the network;
Providing user interface for end uses to enter and submit resource URLs for archiving the contents of the resources addressed by the user provided resource URLs, and the contents of the resource addressed by the URLs referenced inside;
Providing a function for displaying archived contents;
Providing a function for sending notification to end users who are interested in receiving notifications for content changes from the contents addressed by resource URLs;

12. The web content management system according to claim 11 wherein said very large repository comprising a collection of contents of the archived resources and a collection of attributes describing the contents of the archived resources;

13. The very large repository according to claim 12 comprising contents stored in a file system and content attributes stored in a relational database;

14. The content attributes according to claim 12 comprising URL strings each addressing a resource on the network;

15. The content attributes according to claim 14 comprising a set of attributes collectively describing single archived resource in said very large repository according to claim 11;

16. The content attributes according to claim 15 further comprising one or more of the following:
Strings identifying the type of the network resource browser program for which the content of the resource is delivered from the network;
Strings or numeric numbers identifying the revisions of the contents;
Strings identifying the content type of the contents;
Strings or numeric numbers identifying the size of the contents prior transformation;
Strings or numeric numbers identifying the date and time when the content has been archived in said very large repository according to claim 11;

17. The content attributes according to claim 16 further comprising unique ID strings identifying an archived resource in said very large repository;

18. The web content management system according to claim 11 wherein said archive URL comprising:
Long form which is an absolute URL fully qualified in order to address an archived resource in said very large repository;
Or short form which is a relative URL qualified to address an archived resource in said very large repository, that is relative to the page and file where it is embedded and optionally relative to the service that delivers the resource addressed by the URL;

19. The archive URL according to claim 18 further comprising said ID string according to claim 17;

20. The web content management system according to claim 11 wherein said archiving function comprising one or more of the following:
Function for downloading resources from the network;
Function for detecting the content type of the downloaded resources;
Function for deciding whether the downloaded resource requires content transformation;
Function for transforming the contents of the downloaded resources for later display;
Function for querying said very large repository according to claim 11;
Function for comparing the downloaded resource with the archived resources for deciding whether the downloaded resource requires saving into said very large repository according to claim 11;
Function for saving the downloaded and optionally transformed resources into said very large repository according to claim 11.

21. The content transformation function according to claim 20 comprising one or more of the following:
Function for parsing the content of a resource in order to identify and extract embedded URLs for external resources;
Function for normalizing URLs, which translates an URL from relative form to absolute form;
Function for downloading resources from the network;
Function for detecting the content type of the downloaded resource;
Function for deciding whether the downloaded resource requires content transformation;
Function for saving the downloaded and optionally transformed resources into said very large repository according to claim 11;
Function for generating archive URLs;
Function for translating a resource URL to the corresponding archive URL;
Function for replacing resource URLs embedded in the content with the corresponding archive URLs;
Function for querying said very large repository according to claim 11;
Function for comparing the downloaded resource with the archived resources for deciding whether the downloaded resource requires saving into said very large repository as a new revision of the archived resources;
Function for invoking the transformation function on the content of a resource downloaded from the network;

22. The content transformation function according to claim 11 further comprising a mechanism for terminating the recursive invocation of said content transformation function;

23. The web content management system according to claim 11 further comprising function for capturing and archiving resources requested from within browser plug-ins through resource URLs that may or may not be publicly available from the content wherein the browser plug-in is embedded;

24. The content attributes according to claim 17 further comprising ID strings identifying resource containers from which secondary resources are requested from within a browser plug-in;

25. The web content management system according to claim 11 wherein said function for displaying the contents of archived resources comprising one or more of the following:
Function for listing a portion or all revisions of the archived resources associated with a specified resource URL;
Function for end user to select one or more revisions from a list of revisions of the archived resources;
Function for displaying the content of a specific revision of the archived resources to end users;
Function for visually comparing the contents of 2 or more revisions of the archived resources;

26. The function for displaying the content of archived resources according to claim 25 further comprising function for marking up the contents of the archived resources with a timestamp representing when the resource is archived into said very large repository according to claim 11;

27. The web content management system according to claim 11 further comprising one or more of the following:
Function for retrieving a list of archive URLs from said very large repository, provided a resource URL;
Function for delivering the list to the clients;
Function for retrieving the content of an archived resource from said very large repository;
Function for delivering the retrieved content to the clients;

28. The content attributes according to claim 17 further comprising ID strings each identify an user registered in said very large repository according to claim 11;

29. The web content management system according to claim 11 further comprising functions for keeping changes to the content of a resource addressed by a resource URL private to users who initiated the archiving of the content of the resource;

30. The content attributes according to claim 15 further comprising one-to-many relationship between a resource URL and a set of ID strings each identifying an user registered in said very large repository according to claim 11;

31. A web browser for archiving web contents:
Providing functions for displaying the contents of resources on the web;
Providing connection to a web content management service that transforms and archives resources on the web for later display as historical records;
Providing function for sending requests to said web content management service for archiving the contents currently displayed in the browser;

32. The web browser according to claim 31 further comprising one or more of the following:
Providing function for sending archiving requests to said web content management service after the content being successfully displayed in the browser window, that the URL string addressing the content is typed into the address bar of the browser;
Providing function for sending archiving requests to said web content management service when user of the browser dragging and dropping an URL into the browser;
Providing function for sending archiving requests to said web content management service when the browser is instantiated with a resource URL as an argument;
Providing function for detecting the URL strings that embedded browser plug-ins use for requesting resources on the web, and sending archiving request to said web content management service when a valid URL is detected;

33. The web browser according to claim 31 further comprising settings for the connection to said web content management service, that user can switch from one service to another and disable/enable the communications with the service;

34. The web browser according to claim 31 wherein said archiving request comprising the absolute URL that addresses a resource on the web;
